(19) United States
(12) Patent Application Publication
(10) Pub. No.: US 2020/0341437 A1
(43) Pub. Date: Oct. 29, 2020

(54) Systems and Methods for Security Constrained Automatic Generation Control

(71) Applicants: Renchang Dai, Sammamish, WA (US); Guangyi Liu, San Jose, CA (US); Jun Tan, San Jose, CA (US); Chen Yuan, San Jose, CA (US); Yi Lu, Chengdu (CN); Zhenjiang Yu, Weifang (CN); Zhiwei Wang, Cupertino, CA (US)

(72) Inventors: Renchang Dai, Sammamish, WA (US); Guangyi Liu, San Jose, CA (US); Jun Tan, San Jose, CA (US); Chen Yuan, San Jose, CA (US); Yi Lu, Chengdu (CN); Zhenjiang Yu, Weifang (CN); Zhiwei Wang, Cupertino, CA (US)

(21) Appl. No.: 16/396,502

(22) Filed: Apr. 26, 2019

(51) Int. Cl. G05B 13/04; G06F 16/901; H02J 3/06; H04W 52/52

(52) U.S. Cl. CPC G05B 13/04; H04W 52/52; H02J 3/06; G06F 16/9024

(57) ABSTRACT

A power system energy management system with security constrained automatic generation control (SCAGC) is disclosed wherein the power generation output and branch power flow are constrained by security limit. A sub-optimization model is used to calculate SCAGC for each control area in parallel. Graph computing is applied to solve the SCAGC by simplex approach in hierarchical parallel and nodal parallel. The SCAGC is solved heuristically first by combining the equal incremental fuel cost ratio and generation shift factor, and if the heuristics do not converge, a simplex method is used to solve the SCAGC.

### BACKGROUND OF THE INVENTION

The teachings herein relate generally to model, approach, and computer program for security constrained automatic generation control (SCAGC) in power systems.

The automatic generation control (AGC) is used to balance active power, regulate tie line power flow while minimize the power generation cost.

In present state of the art, the AGC base point is determined by the Economic Dispatch (ED) and AGC regulates the Area Control Error (ACE) to be zero and controls the tie line power flow to the desired command.

ED optimizes generation under the network security constraints. There are two commonly used methods for active economic dispatch in power systems: (1) Offline Economic Dispatch and (2) Online Economic Dispatch.

Off-line economic dispatch calculates unit commitment and dispatches unit active power output for the next day or the next few days in a time interval of hours based on the generation capacity, grid network constraints, as well as the forecasted load.

Since off-line economic dispatch is based on load forecasting, the generation dispatch may not accurately meet the actual load. The operating conditions of the power system are changing, and the active power output of the generators may deviate from the scheduled power generation setpoint. Therefore, on-line economic dispatch adjusts the generation output set by offline economic dispatch continuously to satisfy the power system actual operating point in a short time interval (5˜15 minutes).

Automatic generation control provides automatic control for online economic dispatch.

AGC is used to control tie line power flow as well. Large scale power system is usually divided into areas. These divided areas are connected by tie lines. Each inter-area tie line power flow is controlled to be a desired value within its transmission capacity limit to ensure the operation security. AGC is functionally designed to control the inter-area tie line power flows.

In practice, for a middle-scale power system, economic dispatch calculation with network security constraints takes minutes. Due to the short cycle of AGC control conflicting with the extensive computation efforts of the security constrained optimization, network security constraints are not modeled in AGC in real-time. When power system operation changes significantly in ED cycle, AGC commands without the present invention cannot guarantee that the network security constraints are satisfied.

Present state of the art assumes the power system operation point does not change significantly enough between two ED executions to push the AGC base point determined by ED to violate network security constraints. This assumption is not always true in power system operation.

In the case of intermittent renewable energy penetrated power systems and fast-response power electronics-based generation integrated transmission and distribution power network, the system power flow has a high probability of shifting away from the base point which is optimized in the cycle of ED. AGC without the present invention does not optimize power flow within network security constraints. With present AGC command, the power flow may result in violations. Thus, the AGC without network security constraints presents risks in power system operation.

When State Estimation (SE) estimates violated power flow, present state of the art heuristically changes generation limits of generators for AGC regulation to alleviate the risk of overflow under AGC command. This approach obviously has drawbacks that it is heuristic and SE execution cycle in minute-scale cannot fit into AGC execution in seconds.

### SUMMARY

The above discussed and other drawbacks and deficiencies are overcome or alleviated by the teachings disclosed herein.

In one aspect, a security constrained AGC device regulates area control error and tie line power flow that includes power flow constraints in the AGC regulation model, wherein branch active power flow is limited in its active power ratings.

In another aspect, also disclosed is a method for using simplex algorithm to solve the security constrained AGC model.

In a further aspect, a sub-optimization model is also disclosed to separate the security constrained AGC optimization problem into several small-scale optimization problems in which each small-scale optimization problem is applied to solve SCAGC for one control area.

In yet another aspect, a parallel computation method using graph based hierarchical parallelism is also disclosed to improve the efficiency of security constrained AGC calculation.

In another aspect, further disclosed is a method of combining equal incremental fuel cost ratio and generation shift factor to quickly update generator active power output to avoid power flow violations.

In another aspect, a method to manage power generation includes separating a power system into one or more control areas by representing each tie line as equivalent loads injected to the tie line connecting buses at two connecting control areas; changing a power flow balance by using equivalent loads to replace a tie line flow; removing the equation in which tie line active power flow equates to its command; and determining a generation summation model, wherein a summation of generation units in each control area equals to a summation of generation units in the same control area with non-security constrained automatic generation control (AGC); wherein an inequality in which generation output of each unit is within its generation capacity; equations to calculate branch power flows; the inequality in which each branch power flow is within its limit; and the objective function in which the total generation fuel cost is minimized.

In a further aspect, a computer program for power management includes code for creating a simplex tableau form for each control area in parallel; code for separating variables in parallel to form a canonical tableau for each control area; code for using an elimination tree to get a pivot operation dependency; code for performing a pivot operation on vertices on the same level; and code for determining SCAGC in parallel for each control area.

In yet another aspect, a power management system with SCAGC is disclosed wherein the power generation output and branch power flow are constrained by security limits. A sub-optimization model is used to calculate SCAGC for each control area in parallel. Graph computing is applied to solve the SCAGC by simplex approach in hierarchical parallel and nodal parallel. The SCAGC is solved heuristically first by combining the equal incremental fuel cost ratio and generation shift factor, and if the heuristics do not converge, a simplex method is used to solve the SCAGC.

Advantages may include one or more of the following. The system optimizes AGC set point under network security constraints in the cycle of AGC execution. The system can operate in real-time using the instant framework. The parallel computation to solve the sub optimization problems can improve the computation efficiency. In comparison, the state of the art of simplex algorithm cannot solve the security constrained AGC for a medium size power system in the cycle of AGC execution time interval in seconds.

The features and advantages of the present invention will be appreciated and understood by those skills in the art from the following detailed description and drawings.

### BRIEF DESCRIPTION OF THE DRAWINGS

The features of the exemplary embodiments believed to be novel and the elements characteristic of the exemplary embodiments are set forth with particularity in the appended claims. Figures are for illustration purposes only and are not drawn to scale. The exemplary embodiments, both as to organization and method of operation, may best be understood by reference to the detailed description which follows taken in conjunction with the accompanying drawings in which:

FIG. 1 is an exemplary diagram of power system which frequency and tie line power flow are regulated by AGC device.

FIG. 2 is an exemplary diagram of AGC related to other functions in power system operation.

FIG. 3 is an exemplary mathematical optimal model of the security constrained AGC.

FIG. 4 depicts exemplary control areas of a power system connected by inter-area tie lines.

FIG. 5 is an exemplary decomposed mathematical optimal model of the security constrained AGC for each control area.

FIG. 6 is an exemplary canonical form of the security constrained AGC sub optimization problem.

FIG. 7 is an exemplary tableau form of the security constrained AGC problem.

FIG. 8 is an exemplary tableau form of the security constrained AGC problem using basic variable and non-basic variables.

FIG. 9 shows an exemplary canonical tableau of security constrained AGC problem.

FIG. 10 is a polytope defining the feasible region of the security constrained AGC model.

FIG. 11 depicts an exemplary graph data structure of security constrained AGC problem tableau form.

FIG. 12 depicts an exemplary elimination tree of the tableau form of the security constrained AGC problem.

FIG. 13 depicts an exemplary pseudo code of the parallel calculation method for forming the elimination tree.

FIG. 14 depicts an exemplary pseudo code of the parallel calculation method for partitioning vertices.

FIG. 15 depicts an exemplary pseudo code of the pivot operation in parallel.

FIG. 16 depicts an exemplary pseudo code of the simplex optimization in parallel.

FIG. 17 depicts an exemplary pseudo code of the simplex algorithm to solve security constrained AGC for each control area in parallel, referred to as “Option A”.

FIG. 18 depicts an exemplary pseudo code to solve the simplified security constrained AGC using equal incremental fuel cost approach and generation shift factor, referred to as “Option B”.

### DETAILED DESCRIPTION OF THE INVENTION

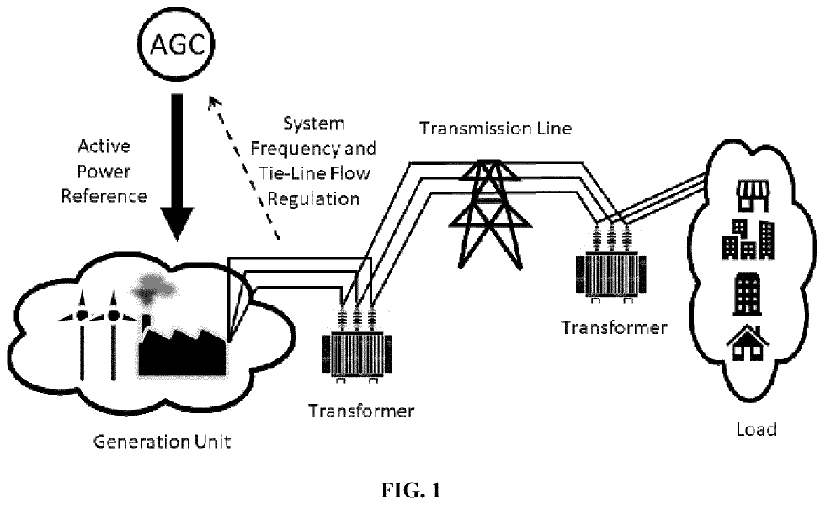

Referring to FIG. 1, a diagram of an exemplary power system is shown where frequency and tie line power flow are regulated by AGC device. The power system of FIG. 1 has five fundamental and core components: (1) power generation; (2) power transmission; (3) power transformation; (4) power distribution; and (5) power consumption. Since it is difficult and expensive to store large scale electricity, power system operation needs to keep the balance of supply and demand. AGC is an important device to regulate tie-line power flow and system frequency, as presented in FIG. 1, by dynamically adjusting the active power output of power generation units. AGC device acquires system frequency at frequency measurement point and power flows of each controlled tie line using telemetering system. The active power output commands generated by AGC are sent to AGC units through communication system.

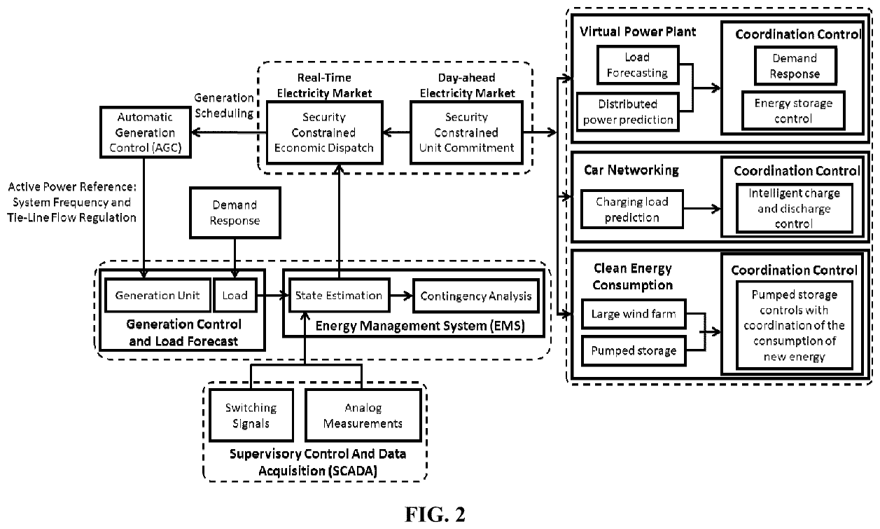

Referring to FIG. 2, a diagram of AGC is shown relative to other functions in power system operation. FIG. 2 shows that security constrained economic dispatch and security constrained unit commitment provide generation scheduling, and AGC regulates generation units' active power output to control system frequency and tie-line power flow with the input of generation scheduling.

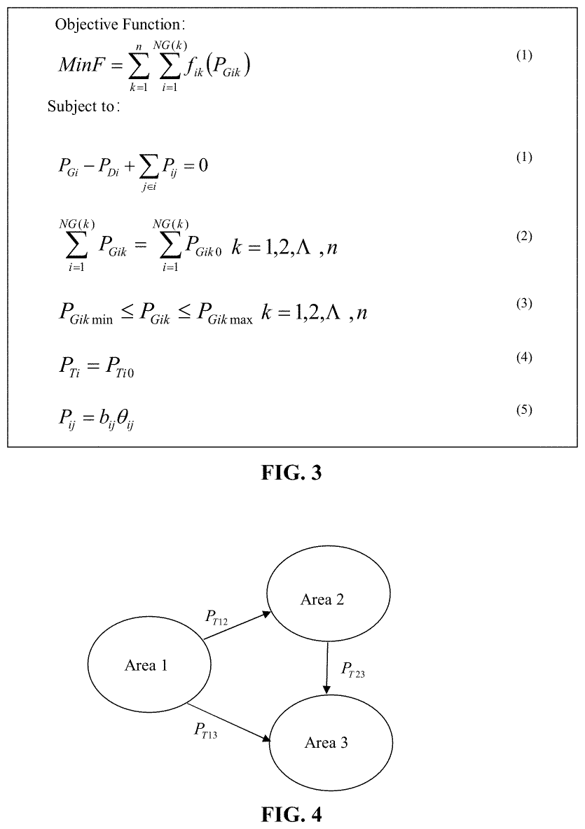

Referring to FIG. 3, a mathematical optimization model of the security constrained AGC is presented. In modern automatic power generation control schemes, the control of each control area is typically determined by a control center. The system frequency, power generation output, branch flow, and device status are telemetered to the control center through the Supervisory Control And Data Acquisition (SCADA) system. The control center determines and transmits the control signal to AGC generators via the SCADA communication channel. The AGC control signal is usually a set of pulse signals. The AGC then adjusts the generation output settings up and down based on the pulse. The approach supports the security constrained AGC function.

The SCAGC model is built upon a non-security constrained AGC model. The SCAGC assumes that the conventional non-security constrained AGC control signal P_{Gik0} has been set by conventional AGC for each AGC unit in each control area. To keep the frequency in each control area and inter-area tie line flow P_{Ti0} unchanged (Equation 5), the total generation output of each control area

$${\sum }_{i = 1}^{N G ( k )} {P}_{G i k 0}$$

should be unchanged (Equation 3). The security constrained AGC model depicted in FIG. 3 adjusts the active power P_{Gik} in each control area k to meet the power balance equation at each bus (Equation 2), and to control the generator output P_{Gik} and line power Pᵢⱼ within operational limits (Equation 4 and Equation 7). The objective function of the optimization is to minimize the total power generation cost (Equation 1). Equation 6 is used to calculate line power flow by DC power flow method.

In the model, the representation of the symbols is listed as follow:

fᵢₖ—the power generation cost function of the i-th unit in area k;

P_{Gik}—the active power output of the i-th unit in area k;

P_{Dik}—the active power of a load at bus i in area k;

P_{Ti}—the active power of the i-th tie line in the system;

P_{Ti0}—the active power of the i-th tie line in the system determined by conventional non-security constrained AGC;

Pᵢⱼ—the active power of line ij;

n—the number of control areas;

NG(k)—the number of generators in area k;

FIG. 4 depicts control areas of a power system connected by inter-area tie lines. FIG. 4 depicts an example of power system with three control areas. The invention can be applied to any number of control areas. As depicted in FIG. 4, the system is separated by control areas connected with inter-area tie lines. AGC regulates generation unit active power to control inter-area tie line power flow at the desired command. The tie line can be represented as equivalent loads matching the desired power flow command. Once the tie lines are replaced by equivalent loads, the power system is separated to independent control areas.

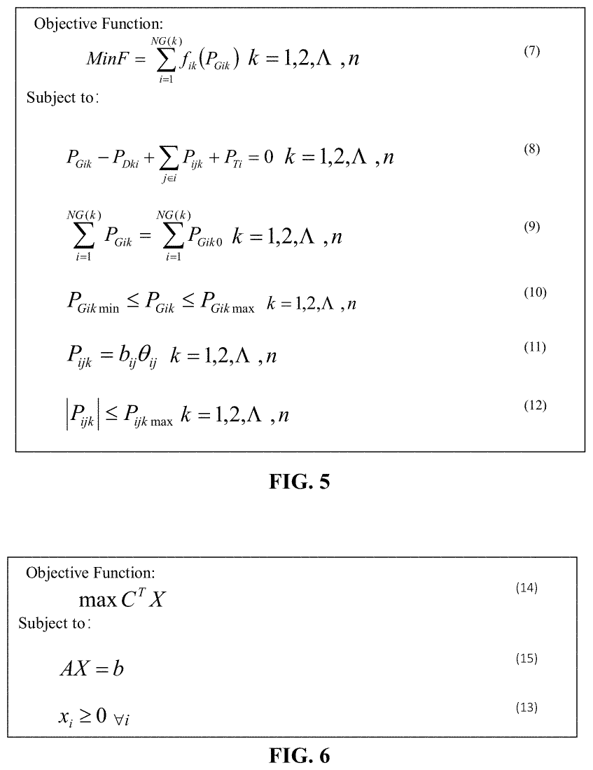

FIG. 5 depicts aspects of security constrained AGC model for each control area. The objective function (Equation 8) and the constrains (Equation 9-Equation 13) are defined for each control area. In the power balance equation 9, the tie line power flow P_{Ti} is known by its command. The whole security constrained AGC problem modeled by Equation 1 to Equation 7 is decomposed to be n sub optimization problems where n is the number of control areas.

FIG. 6 depicts the canonical form of the security constrained AGC sub optimization problem. The canonical form assumes the objective function is linear where C is the coefficient vector of the objective function.

FIG. 7 depicts the tableau form of the security constrained AGC problem. The first row of the tableau form defines the objective function and the remaining rows specify the constraints.

FIG. 8 reforms the tableau form of the security constrained AGC problem using basic variable and non-basic variables. The non-basic variables can be represented by basic variables linearly.

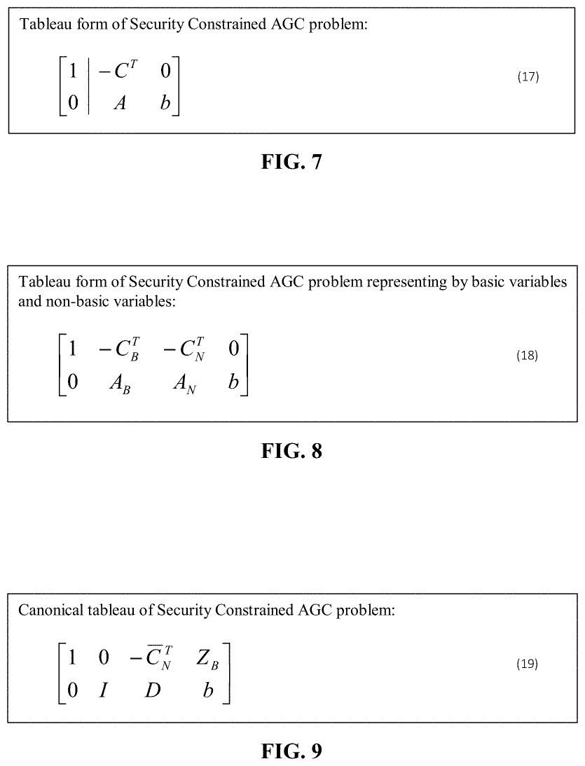

Additional elimination can be applied to remove the coefficients C_{B}^{T}, from the objective function and results in a canonical tableau in FIG. 9, where Z_{B} is the value of the objective function at the corresponding basic feasible solution. The updated coefficients C̅_{N}^{T} are the rates of change of the objective function with respect to the non-basic variables. And the second row of the canonical tableau can be applied to solve non-basic variables.

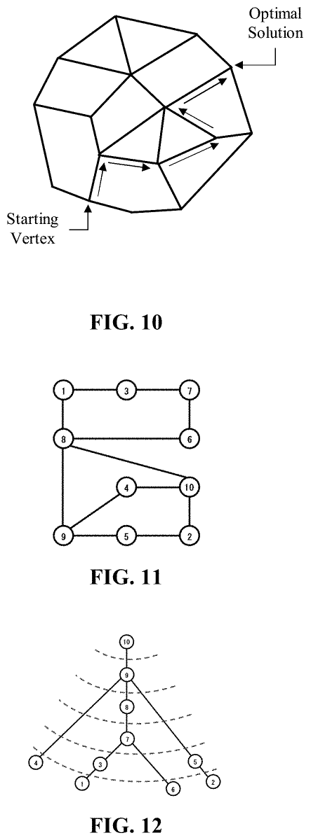

The elimination operation to form the canonical tableau in FIG. 9 is a pivot operation which moves a basic feasible solution to an adjacent basic feasible solution in the simplex. FIG. 10 depicts a polytope defining the feasible region of the security constrained AGC model. The pivot operation begins at a starting vertex and moves along the edges of the polytope until it reaches the vertex of the optimal solution.

In the pivot operation, a nonzero pivot element is selected in a non-basic column in C_{N}^{T}. The row containing this element is multiplied by its reciprocal to change this element to 1, and then multiples of the row are added to the other rows to change the other entries in the column to 0. The result is that, if the pivot element is in row r, then the column becomes the r-th column of the identity matrix. The variable for this column is now a basic variable, replacing the variable which corresponded to the r-th column of the identity matrix before the operation. In effect, the variable corresponding to the pivot column enters the set of basic variables and is called the entering variable, and the variable being replaced leaves the set of basic variables and is called the leaving variable. The tableau is still in canonical form but with the set of basic variables changed by one element.

The simplex algorithm proceeds by performing successive pivot operations each of which gives an improved basic feasible solution; the choice of pivot element at each step is largely determined by the requirement that this pivot improves the solution.

Since the entering variable will, in general, increase from 0 to a positive number, the value of the objective function will decrease if the coefficient of the objective function with respect to this variable is negative. Equivalently, the value of the objective function is decreased if the pivot column is selected so that the corresponding entry in the objective row of the tableau is positive. If all the entries in the objective row are less than or equal to 0 then no choice of entering variable can be made and the solution is in fact optimal, then the objective is optimal.

Once the pivot column has been selected, the choice of pivot row is largely determined by the requirement that the resulting solution be feasible. First, only positive entries in the pivot column are considered since this guarantees that the value of the entering variable will be nonnegative. If there are no positive entries in the pivot column then the entering variable can take any non-negative value with the solution remaining feasible. In this case the objective function is unbounded below and there is no minimum.

Next, the pivot row must be selected so that all the other basic variables remain positive. This occurs when the resulting value of the entering variable is at a minimum.

The parallel computation to solve the sub optimization problems can improve the computation efficiency, the state of the art of simplex algorithm cannot solve the security constrained AGC for a medium size power system in the cycle of AGC execution time interval in seconds.

The elimination process is engaged in the pivot operation to update the rows. The elimination on one row depends on some of rows but not all the rows. The elimination tree provides the information on column dependencies in the pivot operation.

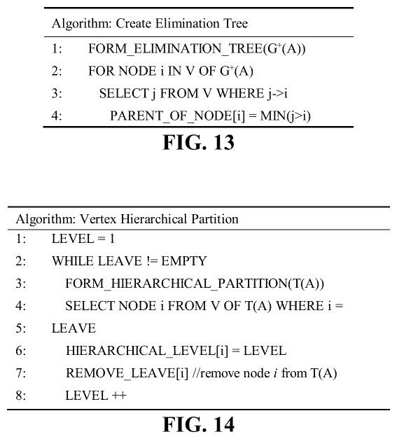

FIG. 11 depicts an example of graph representing the relationship of the variables in the tableau form of Security Constrained AGC problem. FIG. 12 depicts the elimination tree of the graph. FIG. 13 is the pseudo code to create an elimination tree.

In graph hierarchical parallel computing, computation is performed in parallel on vertices at the same depth level of the elimination tree. The vertices are partitioned into different levels in the elimination tree according to their calculation dependency in FIG. 14. The calculation of quantities associated with the higher-indexed-level vertices depends on the calculation of quantities associated with the lower level vertices. The calculations associated with vertices at the same level are independent and are performed in parallel.

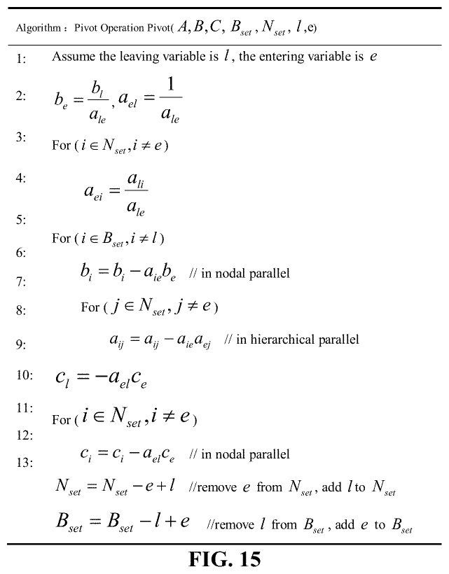

In FIG. 15, the pivot operation moves the selected leaving variable from the basic variables to non-basic variables and moves the selected entering variable from the non-basic variables to basic variable. The pivot operation updates the tableau form using a similar way as Gaussian elimination.

In FIG. 15, the representation of the symbols is listed as follow:

l—the leaving variable in pivot operation;

e—the entering variable in pivot operation;

aᵢⱼ—the element in the matrix A in the Form 17 as shown in FIG. 7: the tableau form of Security Constrained AGC problem;

bᵢ—the element in the right-hand side vector B of the constrains in the Form 17;

cᵢ—the element in the coefficient vector C of the objective function in the Form 17;

Nₛₑₜ—the non-basic variable set;

Bₛₑₜ—the basic variable set;

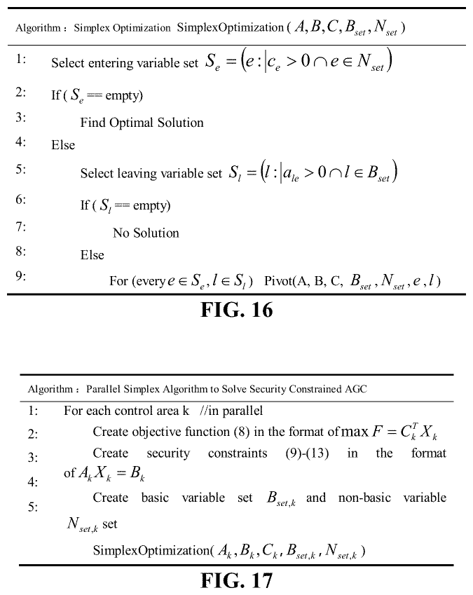

In FIG. 16, the simplex optimization process selects the leaving variables and the entering variables to optimize the objective function and meanwhile meet the constraints.

In FIG. 16, the representation of the symbols is listed as follow:

Sₑ—the selected entering variable set;

Sₗ—the selected leaving variable set;

In FIG. 15 and FIG. 16, parallel computing is applied to perform pivot operation and simplex optimization.

FIG. 17 depicts the parallel simplex algorithm to solve security constrained AGC (“Option A”). In FIG. 17, parallel computing is applied to solve security constrained AGC. In this parallel algorithm, simplex tableau form (Form 17) is created for each control area in parallel. The basic variables and non-basic variables are separated to form canonical tableau (Form 18 as shown in FIG. 8) for each control area. The process to form the canonical tableau is independent from one control area to another. The Form 18 is created in parallel.

The elimination tree is formed to get the pivot operation dependency for each of the vertices on the graph by using the algorithm depicted in FIG. 13. The pivot operation on the vertices on the same level is performed in parallel. After the lower level vertices are performed, the upper level vertices are performed in parallel.

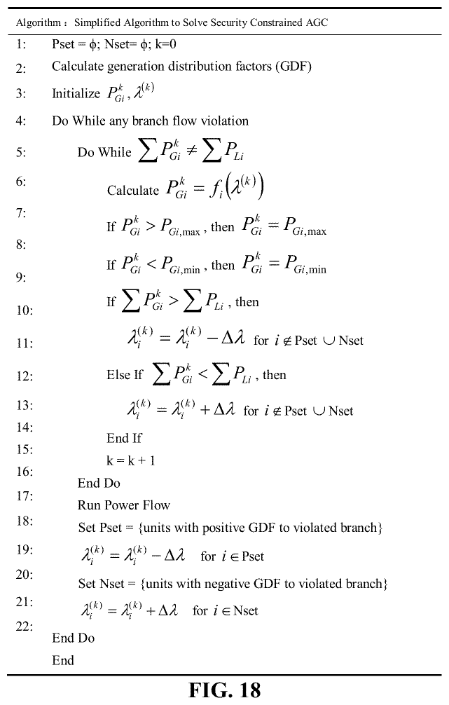

“Option B” depicted in FIG. 18 is used to simplify the process to solve the security constrained AGC. In FIG. 18, the representation of the symbols is listed as follow:

Pₛₑₜ—the unit set in which unit has positive generation shift factor to violated branches;

Nₛₑₜ—the unit set in which unit has negative generation shift factor to violated branches;

ϕ—empty set;

k—iteration number;

P_{Gi}^{k}—the active power generation of the i-th unit at the iteration number k;

λ^{(k)}—the equal incremental fuel cost ratio at the iteration number k;

P_{Li}—the active power of the i-th load;

fᵢ(λ^{(k)})—the fuel cost function of the i-th unit at the iteration number k;

“Option B” is heuristic and convergence is not guaranteed. When “Option B” is diverged, switching to “Option A” to solve the security constrained AGC problem.

As will be appreciated by one skilled in the art, aspects of the exemplary embodiments may be embodied as a system, method, service method or computer program product. Accordingly, aspects of the exemplary embodiments may take the form of an entirely hardware embodiment, an entirely software embodiment (including firmware, resident software, micro-code, etc.) or an embodiment combining software and hardware aspects that may all generally be referred to herein as a “circuit,” “module”, “machine”, or “system.” Furthermore, aspects of the exemplary embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the exemplary embodiments may be written in any combination of one or more programming languages, including an object-oriented programming language such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the exemplary embodiments have been described above with reference to flowchart illustrations and/or block diagrams of methods, apparatus (systems) and computer program products according to the exemplary embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and/or block diagrams in figures illustrate the architecture, functionality, and operation of possible implementations of systems, methods, service methods and computer program products according to the exemplary embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be apparent to those skilled in the art having regard to this disclosure that other modifications of the exemplary embodiments beyond those embodiments specifically described here may be made without departing from the spirit of the invention. Accordingly, such modifications are considered within the scope of the invention as limited solely by the appended claims.

What is claimed is:

1. A system, comprising:
a processor to receive data from the power system; and
computer readable code to perform security constrained automatic generation control (SCAGC), the code providing an automatic generation control signal while conforming to a generation capacity limit and a network security limit.

2. The system of claim 1, comprising code to maintain an active power balance at each bus of the power system.

3. The system of claim 1, wherein a summation of a generation of units in each control area equals to a summation of generation of units in the same control area given by non-security constrained automatic generation control.

4. The system of claim 1, wherein a generation output of unit is within a generation capacity.

5. The system of claim 1, wherein the power system comprises a power generator, a load, a transmission line and an automatic generation control module.

6. The system of claim 1, wherein branch power flow is kept within a limit.

7. The system of claim 1, comprising code with an objective function in which a total generation fuel cost is minimized.

8. A method to manage power generation, comprising:
separating a power system into one or more control areas by representing each tie line as equivalent loads injected to the tie line connecting buses at two connecting control areas;
changing a power flow balance by using equivalent loads to replace a tie line flow;
removing a restriction where a tie line active power flow equates to its command; and,
determining a generation summation model, wherein a summation of generation units in each control area equals to a summation of generation units in the same control area by non-security constrained automatic generation control (AGC); wherein an inequality in which generation output of each unit is within its generation capacity; equations to calculate branch power flows; the inequality in which each branch power flow is within its limit; and the objective function in which the total generation fuel cost is minimized.

9. A computer program for power management, comprising:
code for creating a simplex tableau form for each control area in parallel;
code for separating variables in parallel to form a canonical tableau for each control area;
code for using an elimination tree to get a pivot operation dependency;
code for performing a pivot operation on vertices in the same level; and
code for determining security constrained automatic generation control (SCAGC) in parallel for each control area.

10. The computer program of claim 9, comprising code for entering variable selection and leaving variable selection are performed in hierarchical parallel based on a vertices partition by elimination tree.

11. The computer program of claim 9, comprising code for eliminating the pivot operation which is performed in hierarchical parallel based on the vertices partition by elimination tree.

12. A computer program to perform security constrained automatic generation control (SCAGC), comprising:
code to use equal incremental fuel cost approach to calculate generation output to meet the system load;
code to calculate a power flow to check branch violation;
code to calculate the generation shift factor;
code to determine a positive unit set having units with a positive generation shift factor to violated branches and a negative unit set having units with a negative generation shift factor to violated branches; and
code to adjust the equal incremental fuel cost ratio for positive unit set, negative unit set, and other units accordingly.

13. The computer program of claim 12, wherein the power flow calculation is using graph computing in parallel.

14. The computer program of claim 12, wherein the branch violation check uses graph computing in parallel.

15. The computer program of claim 12, wherein the generation shift factor calculation is using graph computing in parallel.

16. The computer program of claim 12, wherein the positive unit set and the negative unit set are selected using parallel graph computing.

17. The computer program of claim 12, wherein equal incremental fuel cost ratios are adjusted using parallel graph computing.

18. The computer program of claim 12, comprising heuristic code to solve SCAGC having a predetermined convergence criteria.

19. The computer program of claim 18, wherein if the heuristic code diverges, the code automatically switches to a simplex method to solve SCAGC.
